(19) United States
(12) Patent Application Publication
(10) Pub. No.: US 2007/0108949 A1
(43) Pub. Date: May 17, 2007

(54) Constant voltage generating apparatus with simple overcurrent/short-circuit protection circuit

(75) Inventor: Tsukasa Ohoka, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/591,518

(22) Filed: Nov. 2, 2006

(30) Foreign Application Priority Data
Nov. 11, 2005 (JP) 2005-327196

(51) Int. Cl. G05F 1/00

(52) U.S. Cl. 323/271

(57) ABSTRACT

In a constant voltage generating apparatus where an output circuit is controlled in accordance with a control voltage, a voltage detection signal generating circuit generates a voltage detection signal in accordance with a difference between an output voltage signal of the output circuit and a first reference signal. A current detection signal generating circuit generates a current detection signal in accordance with a difference between an output current signal of the output circuit and a second reference signal. A control current generating circuit generates a control current in accordance with the voltage detection signal and the current detection signal. A control current-to-control voltage converting circuit converts the control current into the control voltage.

### BACKGROUND OF THE INVENTION

1. Field of the Invention

The present invention relates to a constant voltage generating apparatus with a simple overcurrent/short-circuit protection circuit.

2. Description of the Related Art

Generally, a first prior art constant voltage generating apparatus is constructed by an output transistor connected between an input terminal and an output terminal, and a voltage detection signal generating circuit serving as a constant voltage control circuit connected between the output terminal and a ground terminal to control the output transistor. For example, the voltage detection signal generating circuit is formed by a voltage divider connected between the output terminal and the ground terminal, and an error amplifier for receiving a divided voltage from the voltage divider and a reference voltage to generate a voltage detection signal for controlling the output transistor, so that an output voltage at the output terminal is brought close to a constant voltage defined by the reference voltage. This will be explained later in detail.

In the above-described first prior art constant voltage generating apparatus, however, if the output terminal is short-circuited via a load or the like to the ground terminal, an overcurrent may flow through the output transistor, so that the output transistor may be heated and destroyed.

In order to avoid such an overcurrent, a second prior art constant voltage generating apparatus is usually provided with an overcurrent/short-circuit protection circuit (see: JP-2002-169618 A) in addition to the elements of the first prior art constant voltage generating apparatus. This also will be explained later in detail.

### SUMMARY OF THE INVENTION

In the above-described second prior art second constant voltage generating apparatus, however, a drooping type current limiting circuit and a fold-back type current limiting circuit are individually provided as the overcurrent/short-circuit protection circuit. As a result, the circuit structure of the constant current generating apparatus is complex, which would increase the manufacturing cost.

Also, since a capacitance of the output transistor is very large, the response characteristics of the constant voltage generating apparatus would deteriorate.

According to the present invention, in a constant voltage generating apparatus where an output circuit is controlled in accordance with a control voltage, a voltage detection signal generating circuit generates a voltage detection signal in accordance with a difference between an output voltage signal of the output circuit and a first reference signal. A current detection signal generating circuit generates a current detection signal in accordance with a difference between an output current signal of the output circuit and a second reference signal. A control current generating circuit generates a control current in accordance with the voltage detection signal and the current detection signal. A control current-to-control voltage converting circuit converts the control current into the control voltage.

### BRIEF DESCRIPTION OF THE DRAWINGS

The present invention will be more clearly understood from the description set forth below, as compared with the prior art, with reference to the accompanying drawings, wherein:

FIG. 1 is a circuit diagram illustrating a first prior art constant voltage generating apparatus;

FIG. 2A is a graph for explaining a drooping type current limiting characteristic required for the constant voltage generating apparatus of FIG. 1;

FIG. 2B is a graph for explaining a fold-back (chevron) type current limiting characteristic required for the constant voltage generating apparatus of FIG. 1;

FIG. 2C is a graph for explaining a drooping/fold-back type current limiting characteristic required for the constant voltage generating apparatus of FIG. 1;

FIG. 3 is a circuit diagram illustrating a second prior art constant voltage generating apparatus;

FIG. 4 is a circuit diagram illustrating a first embodiment of the constant voltage generating apparatus according the present invention;

FIG. 5A is a detailed circuit diagram of the reference voltage generating circuit of FIG. 4;

FIG. 5B is a table for explaining the operation of the reference voltage generating circuit of FIG. 5A;

FIG. 6 is a circuit diagram illustrating a second embodiment of the constant voltage generating apparatus according the present invention;

FIG. 7 is a circuit diagram illustrating a third embodiment of the constant voltage generating apparatus according the present invention; and

FIG. 8 is a circuit diagram illustrating a fourth embodiment of the constant voltage generating apparatus according the present invention.

### DESCRIPTION OF THE PREFERRED EMBODIMENTS

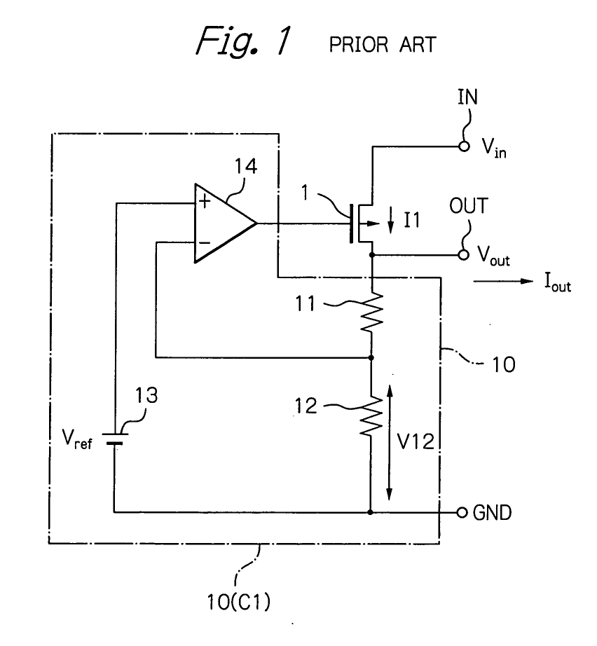

Before the description of the preferred embodiments, a prior art constant voltage generating apparatus will be explained with reference to FIGS. 1, 2A, 2B, 2C and 3.

In FIG. 1, which illustrates a first prior art constant voltage generating apparatus, an input voltage Vᵢₙ and a voltage of 0V are applied to an input terminal IN and a ground terminal GND, respectively. Also, an output p-channel MOS transistor 1 is connected between the input terminal IN and an output terminal OUT. Further, a voltage detection signal generating circuit 10 serving as a constant voltage control circuit C1 is connected between the output terminal OUT and the ground terminal GND to control the output MOS transistor 1.

The voltage detection signal generating circuit 10 is constructed by a voltage divider formed by resistors 11 and 12 connected in series between the output terminal OUT and the ground terminal GND, a reference voltage source 13 and an error amplifier 14 formed by an operational amplifier.

Note that an output voltage and an output current at the output terminal OUT are defined by Vₒᵤₜ and Iₒᵤₜ, respectively.

The ON-current of the output MOS transistor 1 is controlled by the error amplifier 14 which has a non-inverting input receiving a reference voltage V_{ref} from the reference voltage source 13 and an inverting input receiving a divided voltage V12 of the output voltage Vₒᵤₜ by the resistors 11 and 12. In this case, the resistance values of the resistors 11 and 12 are so large that most of a current 11 flowing through the output MOS transistor 1 forms the output current Iₒᵤₜ. As a result, the error amplifier 14 generates an error voltage between the divided voltage V12 and the reference voltage V_{ref} as a voltage detection signal for controlling the output MOS transistor 1, so that the output voltage Vₒᵤₜ is brought close to a limit voltage Vₘ defined by
Vₒᵤₜ=Vₘ=V_{ref}·(R11+R12)/R12

where R11 and R12 are resistance values of the resistors 11 and 12, respectively.

In the constant voltage generating apparatus of FIG. 1, however, if the output terminal OUT is short-circuited via a load (not shown) or the like to the ground terminal GND, an overcurrent may flow through the output MOS transistor 1, so that the output MOS transistor 1 may be heated and destroyed. Therefore, an overcurrent protection function and a short-circuit protection function are required.

The overcurrent protection function is provided to prevent the output current Iₒᵤₜ from exceeding a limit current Iₘ. On the other hand, the short-circuit protection function is provided to decrease the output current Iₒᵤₜ to a short-circuit current Iₛ to suppress the heating of the output MOS transistor, when the output terminal OUT is short-circuited to the ground terminal GND.

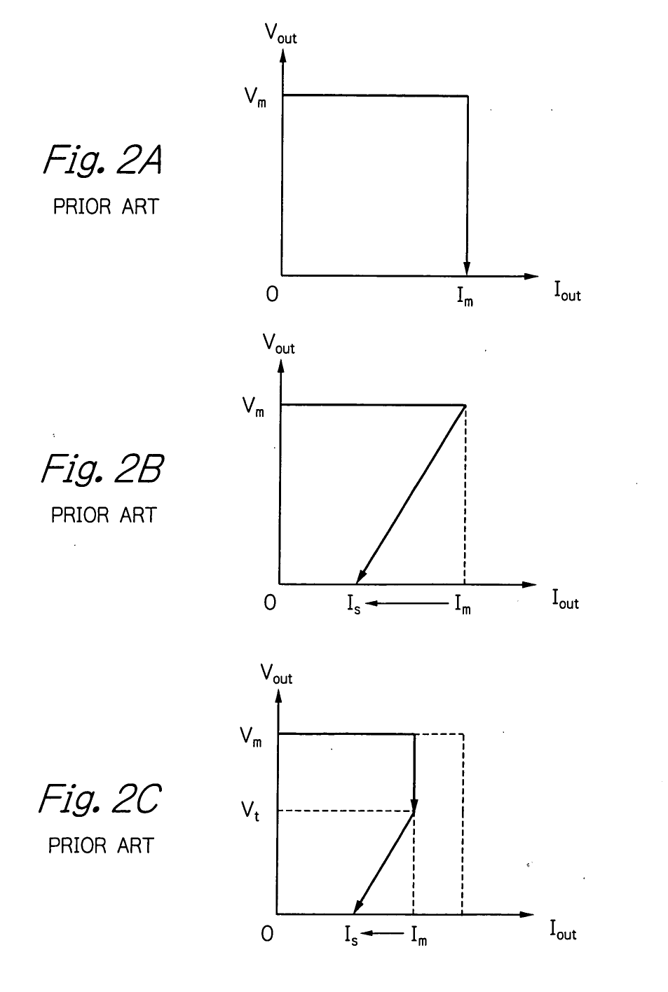

The overcurrent protection function is realized by a drooping type current limiting characteristic as shown in FIG. 2A. Also, the overcurrent protection function and the short-circuit protection function are realized by a fold-back (chevron) type current limiting characteristic as shown in FIG. 2B, or a drooping/fold-back type current limiting characteristic as shown in FIG. 2C.

In the drooping type current limiting characteristic of FIG. 2A, the output voltage Vₒᵤₜ is Vₘ before the output current Iₒᵤₜ reaches the limit current Iₘ. When the output current Iₒᵤₜ reaches the limit current Iₘ, the output voltage Vₒᵤₜ is forcibly decreased to 0V while the output current Iₒᵤₜ remains at the limit current Iₘ.

In the fold-back (chevron) type current limiting characteristic of FIG. 2B, the output voltage Vₒᵤₜ is the limit voltage Vₘ before the output current Iₒᵤₜ reaches the limit current Iₘ. When the output current Iₒᵤₜ reaches the limit current Iₘ, the output voltage Vₒᵤₜ is gradually decreased to 0V and simultaneously, the output current Iₒᵤₜ is gradually decreased to the short-circuit current Iₛ.

In the drooping/fold-back type current limiting characteristic of FIG. 2C, the output voltage Vₒᵤₜ is the limit voltage Vₘ before the output current Iₒᵤₜ reaches the limit current Iₘ. When the output current Iₒᵤₜ reaches the limit current Iₘ, first, the output voltage Vₒᵤₜ is forcibly decreased to Vₜ while the output current Iₒᵤₜ remains at the limit current Iₘ. Thereafter, the output voltage Vₒᵤₜ is gradually decreased to 0V, and simultaneously, the output current Iₒᵤₜ is gradually decreased to the short-circuit current Iₛ.

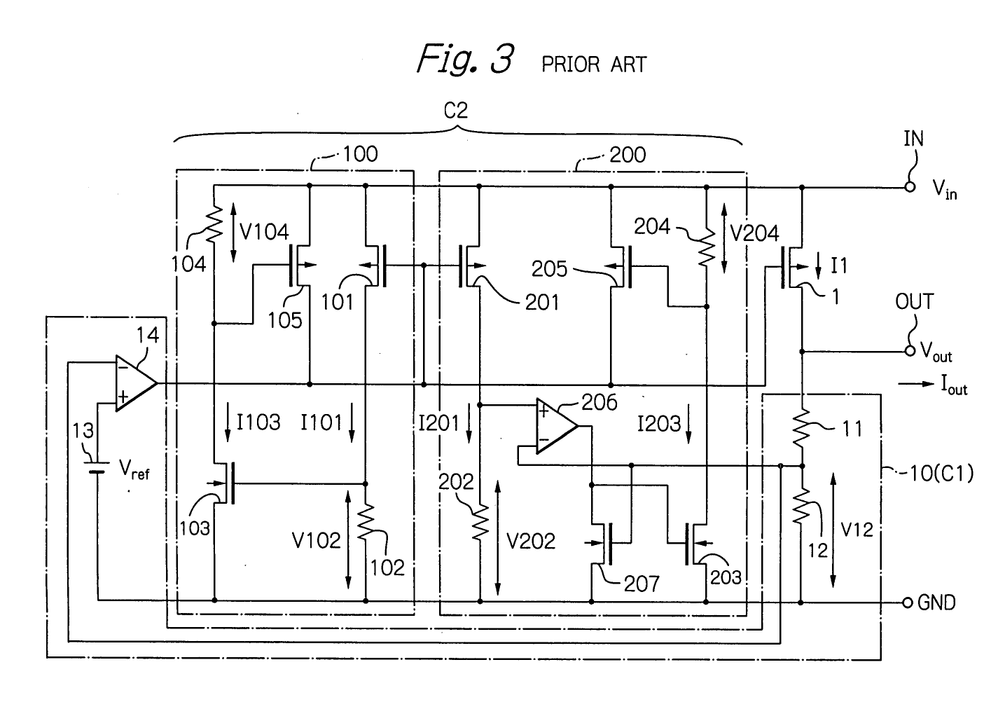

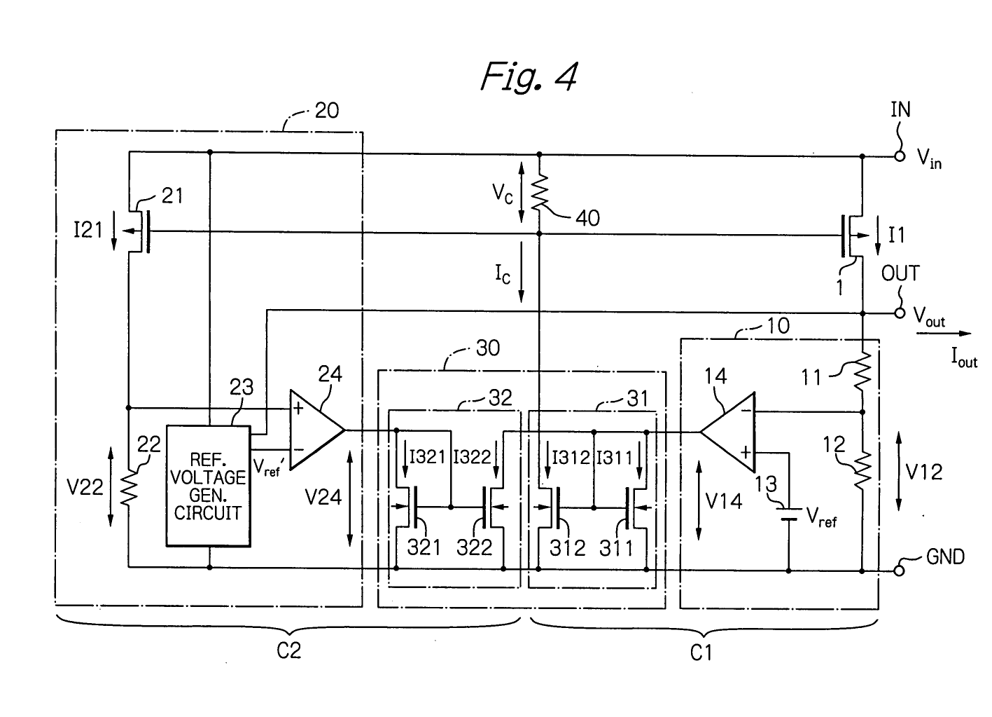

In FIG. 3, which illustrates a second prior art constant voltage generating apparatus (see: FIG. 4 of JP-2002-169618 A), in order to realize the drooping/fold-back type current limiting characteristic of FIG. 2C, a drooping type current limiting circuit 100 and a fold-back type current limiting circuit 200 are added as an overcurrent/short-circuit protection circuit C2 to the elements of FIG. 1.

The drooping type current limiting circuit 100 is constructed by a p-channel MOS transistor 101 forming a mirror circuit with the output MOS transistor 1. Since a current I101 in proportion to the output current Iₒᵤₜ flows through a resistor 102, a voltage V102 (=I101·R102) is generated in the resistor 102 whose resistance is denoted by R102. When the voltage V102 is larger than a threshold voltage of an n-channel MOS transistor 103, the MOS transistor 103 is turned ON so that a current I103 flows therethrough. Also, since the current I103 flows through a resistor 104, a voltage V104 (=I103·R104) is generated in the resistor 104 whose resistance is denoted by R104. When the voltage V104 is larger than an absolute value of a threshold voltage of a p-channel MOS transistor 105, the MOS transistor 105 is turned ON so that the gate voltage of the output MOS transistor 1 is increased, thus decreasing the output voltage Vₒᵤₜ. In this case, if the threshold voltage of the MOS transistor 103 corresponds to the limit current Iₘ, a drooping current limiting characteristic can be realized.

The fold-back type current limiting circuit 200 is constructed by a p-channel MOS transistor 201 a resistor 202, an n-channel MOS transistor 203, a resistor 204 and a p-channel MOS transistor 205 corresponding to the p-channel MOS transistor 101, the resistor 102, the n-channel MOS transistor 103, the resistor 104 and the p-channel MOS transistor 105, respectively, of the drooping type current limiting circuit 100. Also, the fold-back type current limiting circuit 200 is constructed by a comparator 206 and an n-channel MOS transistor 207.

Since a current I201 in proportion to the output current Iₒᵤₜ flows through a resistor 202, a voltage V202 (=I201·R202) is generated in the resistor 202 whose resistance is denoted by R202. The voltage V202 of the resistor 202 and the voltage V12 of the resistor 12 are supplied to a non-inverting input and an inverting input of the comparator 206 which has an offset α, so that a voltage of (V202-α) is brought close to V12.

Only when the MOS transistor 203 is turned OFF by the output voltage of the comparator 206, is the control of the output MOS transistor 1 carried out. In other words, when the MOS transistor 203 is turned ON by the output voltage of the comparator 206, the MOS transistor 203 is turned ON, so that the control of the output MOS transistor 1 is not carried out.

In an overload state where V202−α≧V12, the output voltage of the comparator 206 is increased. As a result, when the output voltage of the comparator 206 is larger than a threshold voltage of the MOS transistor 203, the MOS transistor 203 is turned ON to increase a current I203 flowing through the resistor 204, so that a voltage V204 (=I203·R204) is increased in the resistor 204 whose resistance is denoted by R204. When the voltage V204 is larger than an absolute value of a threshold voltage of the MOS transistor 205, the MOS transistor 205 is turned ON so that the gate voltage of the output MOS transistor 1 is also increased, thus decreasing the output voltage Vₒᵤₜ.

Simultaneously, in the above-described overload state, the voltage V12 of the resistor 12 is gradually decreased, so that the output current Iₒᵤₜ is gradually decreased.

Thus, in the overload state, the output voltage Vₒᵤₜ and the output current Iₒᵤₜ are both gradually decreased, which can realize a fold-back (chevron) current limiting characteristic, if the MOS transistor 207 is not provided and the threshold voltage of the MOS transistor 203 corresponds to the limit current Iₘ.

On the other hand, if the MOS transistor 207 is present as illustrated in FIG. 3, when the divided voltage V12 is larger than the threshold voltage of the MOS transistor 207, the MOS transistor 207 is turned ON to turn OFF the MOS transistor 203. Thus, if the threshold voltage of the MOS transistor 207 corresponds to Vₜ, only when the output voltage Vₒᵤₜ is smaller than Vₜ, are the output voltage Vₒᵤₜ and the output current Iₒᵤₜ both gradually decreased, which can realize a drooping/fold-back current limiting characteristic.

In the constant voltage generating apparatus of FIG. 3, however, since the drooping type current limiting circuit 100 is constructed by the elements 101 through 105 and the fold-back type current limiting circuit 200 is constructed by the elements 201 through 205 corresponding to the elements 101 through 205 corresponding to the elements 101 through 105 of the drooping type current limiting circuit 100 as well as the comparator 206 and the MOS transistor 207; in other words, the drooping type current limiting circuit 100 and the fold-back type current limiting circuit 200 are individually provided as an overcurrent/short-circuit protection circuit, the circuit structure is complex, which would increase the manufacturing cost.

Also, since the MOS transistors 105 and 205 are connected to the gate of the output MOS transistor 1, a capacitance connected thereto is increased so that the response characteristics such as a load response characteristic and an oscillation characteristic would deteriorate.

Further, since use is made of a linear region of the MOS transistor 1, the limit current Iₘ would greatly deteriorate due to the characteristic fluctuation of the MOS transistor 205.

Additionally, when the output MOS transistor 1 is powered ON, the comparator 206 would reverse its output voltage, which would invite an erroneous operation.

Still, even when the MOS transistor 207 is omitted, a complete fold-back (chevron) type current characteristic cannot be obtained.

In FIG. 4, which illustrates a first embodiment of the constant voltage generating apparatus according to the present invention, a current detection signal generating circuit 20, a control current generating circuit 30 and a control current-to-control voltage converting circuit 40 are added to the elements of FIG. 1.

In FIG. 4, the voltage detection signal detecting circuit 10 and the current mirror circuit 31 form a constant voltage control circuit C1, while the current detection signal generating circuit 20 and the current mirror circuit 32 form an overcurrent or short-circuit protection circuit C2. In other words, the current detection signal generating circuit 20 and the current mirror circuit 32 serve as the drooping type current limiting circuit 100 and the fold-back type current limiting circuit 200 of FIG. 3.

The current detection signal generating circuit 20 is constructed by a p-channel MOS transistor 21 forming a current mirror circuit with the output MOS transistor 1, a resistor 22, a reference voltage generating circuit 23 for generating a reference voltage V_{ref}′ which is fixed or variable, and a comparator 24 for comparing a voltage V22 in the resistor 22 with the reference voltage V_{ref}′ to generate a current detection signal (comparison output) V24.

In more detail, a current I21 in proportion to the output current Iₒᵤₜ flows through the resistor 22 so that the voltage V22 (=I21·R22) is generated in the resistor 22 whose resistance is denoted by R122. As a result, when V22≧V_{ref}′, the current detection signal V24 of the comparator 24 is increased. On the other hand, when V22<V_{ref}′, the current detection signal V24 of the comparator 24 is decreased.

The control current generating circuit 30 is constructed by a current mirror circuit 31 connected to the voltage detection signal detecting circuit 10 and a current mirror circuit 32 connected to the current detection signal generating circuit 20.

The current mirror circuit 31 is constructed by an input n-channel MOS transistor 311 connected between the output of the error amplifier 14 and the ground terminal GND, and an output n-channel MOS transistor 312 connected between the control current-to-control voltage converting circuit 40 and the ground terminal GND. The gates of the MOS transistors 311 and 312 are commonly controlled by the voltage detection signal V14 of the error amplifier 14. Therefore, a current I311 in response to the voltage detection signal V14 of the error amplifier 14 flows through the MOS transistor 311, so that a current I312 in response to the current I311 flows through the MOS transistor 312.

The current mirror circuit 32 is constructed by an input n-channel MOS transistor 321 connected between the output of the comparator 24 and the ground terminal GND, and an output n-channel MOS transistor 322 connected between the output of the error amplifier 14 and the ground terminal GND. The gates of the MOS transistors 321 and 322 are controlled by the current detection signal V24 of the comparator 24. Therefore, a current I321 in response to the current detection signal V24 of the comparator 24 flows through the MOS transistor 321, so that a current I322 in response to the current I321 flows through the MOS transistor 322.

The current I322 of the current mirror circuit 32 is also supplied from the current mirror circuit 31. Therefore, the current mirror circuit 32 decreases the currents I311 and I312 of the current mirror circuit 31 to decrease the drive power of the error amplifier 14. That is, if the current flowing through the MOS transistor 312 determined only by the error amplifier 14 is denoted by I312₀,
I312=I312₀−I322.

Therefore, if the current detection signal V24 is increased, the current I322 is increased so that the current I312 is decreased.

Note that the control current generating circuit 30 generates a control current I_{c} (=I312).

In other words, the current mirror circuits 31 and 32 are combined with each other so that the control current I_{c} is determined in accordance with a difference between the output currents of the current mirror circuits 31 and 32.

The control current-to-control voltage converting circuit 40 is constructed by a resistor which generates a control voltage V_{c} by

$$\begin{matrix}{V}_{C} = {I}_{C} \cdot R 40 \\ = I 312 \cdot R 40\end{matrix}$$

where R40 is a resistance value of the resistor of the circuit 40. The control voltage V_{c} is supplied to the output MOS transistor 1. For example, when the control current I_{c}, is decreased, the control voltage V_{c} is decreased to decrease the absolute value of the gate voltage of the output MOS transistor 1. On the other hand, when the control current I_{c} is increased, the control voltage V_{c} is increased to increase the absolute value of the gate voltage of the output MOS transistor 1.

The operation of the constant voltage generating apparatus of FIG. 4 is explained next.

First, until the output current Iₒᵤₜ reaches the limit current Iₘ, the output voltage Vₒᵤₜ is controlled by the constant voltage control circuit C1 so that the output voltage Vₒᵤₜ is brought close to the limit voltage Vₘ. In this case, the protection circuit C2 is not operated so that the overcurrent protection or short-circuit protection is not carried out. That is, in the constant voltage control circuit C1, the voltage detection signal (error voltage) V14 is generated by the error amplifier 14. Since no current flows through the current mirror circuit 32, the control current I_{c}, i.e., the control voltage V_{c} is determined only by the current mirror circuit 31, i.e., the voltage detection signal V14. As a result, the output MOS transistor 1 is controlled by the control voltage V_{c} so that the output voltage Vₒᵤₜ is brought close to Vₘ.

In more detail, when Vₒᵤₜ≧Vₘ, the voltage detection signal (error voltage) V14 is decreased to decrease the current I312 (=I_{c}). Thus, the absolute value of gate voltage of the output MOS transistor 1 is increased so that the output voltage Vₒᵤₜ is decreased. On the other hand, when Vₒᵤₜ<Vₘ, the voltage detection signal (error voltage) V14 is increased to increase the current I312 (=I_{c}). Thus, the absolute value of gate voltage of the output MOS transistor 1 is decreased so that the output voltage Vₒᵤₜ is increased.

Next, when the output current Iₒᵤₜ reaches the limit current Iₘ defined by the reference voltage V_{ref}′, the overcurrent or short-circuit protection circuit C2 is operated. That is, the voltage V22 generated in the resistor 22 by the current I21 in response to the output current I1 flowing through the output MOS transistor 1 reaches the reference voltage V_{ref}′ generated from the reference voltage generating circuit 23. As a result, the current detection signal (output voltage) V24 of the comparator 24 is reversed, so that current I322 flows in the current mirror circuit 32 in response to the current detection signal V24. As a result, since the control current I is represented by the current I312 minus the current I322, the control current I_{c} is decreased so that the control voltage V_{c} is decreased. Thus, the absolute value of the gate voltage of the output MOS transistor 1 is decreased to limit the output current Iₒᵤₜ.

If the reference voltage V_{ref}′ is fixed, i.e., if the limit current Iₘ is fixed, when the output current Iₒᵤₜ becomes larger than the limit current Iₘ, the output current Iₒᵤₜ is always guarded by the limit current Iₘ, so that the drooping type current limiting characteristic as shown in FIG. 2A is obtained.

If the reference voltage V_{ref}′ is variable and is decreased as the output voltage Vₒᵤₜ is decreased, i.e., if the limit current Iₘ is decreased as the output voltage Vₒᵤₜ is decreased, when the output current Iₒᵤₜ becomes larger than the limit current Iₘ, the output current Iₒᵤₜ is gradually decreased to Iₛ as the output voltage Vₒᵤₜ is gradually decreased to 0V, so that the fold-back (chevron) type current limiting characteristic as shown in FIG. 2B is obtained.

If the reference voltage V_{ref}′ is first fixed, and then, the reference voltage V_{ref}′ is variable and is decreased as the output voltage Vₒᵤₜ is decreased, i.e., if the limit current Iₘ is first fixed, and then the limit current Iₘ is decreased as the output voltage Vₒᵤₜ is decreased, when the output current Iₒᵤₜ becomes larger than the limit current Iₘ, the output current Iₒᵤₜ is first fixed, and then is gradually decreased to Iₛ as the output voltage Vₒᵤₜ is gradually decreased to 0V, so that the drooping/fold-back type current limiting characteristic as shown in FIG. 2C is obtained.

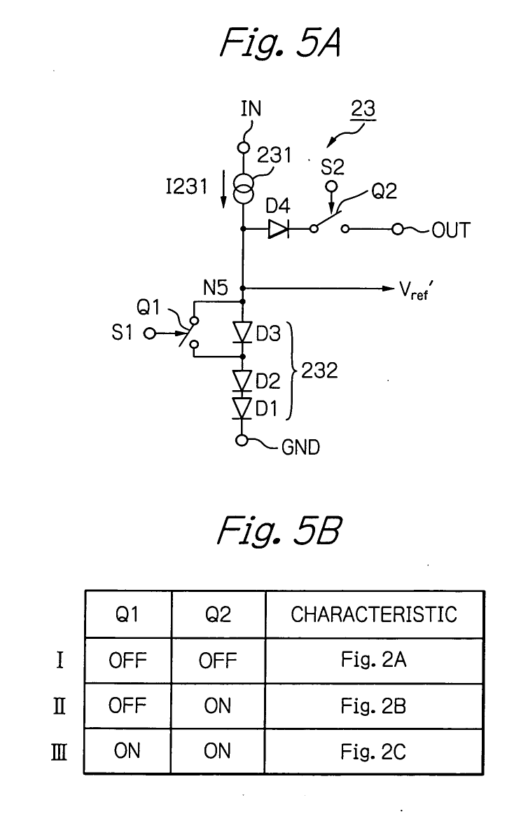

The reference voltage generating circuit 23 of FIG. 4 is explained next with reference to FIG. 5A and 5B.

In FIG. 5A, which is a detailed circuit diagram of the reference voltage generating circuit 23 of FIG. 4, the reference voltage generating circuit 23 is constructed by a constant current source 231 where a constant current I231 flows therethrough and a diode circuit 232 formed by diodes D1, D2 and D3 connected in series between the input terminal IN and the ground terminal GND, and a diode D4 connected between a node N5 of the constant current source 231 and the diode circuit 232 and the output terminal OUT. In this case, the cathode of the diode D1 is connected to the ground terminal GND, the cathode of the diode D2 is connected to the anode of the diode D1, the cathode of the diode D3 is connected to the anode of the diode D2, the anode of the diode D3 is connected to the node N5, the anode of the diode D4 is connected to the node N5, and the cathode of the diode D4 is connected to the switch Q2. The node N5 is adapted to generate the reference voltage V_{ref}′. Note that the number of diodes in the diode circuit 232 can be 2, 4, 5, . . . . Also, the switch Q2 can be connected between the node N5 and the anode of the diode D4.

For example, the switches Q1 and Q2 are formed by N-channel MOS transistors whose gate voltages are controlled by voltages at electrodes (pads) S1 and S2, respectively.

As indicated by I in FIG. 5B, when the switches Q1 and Q2 are both turned OFF, the reference voltage V_{ref}′ is fixed by the diodes D1, D2 and D3. In this case, the fixed value of the reference voltage V_{ref}′ corresponds to the limit current Iₘ of FIG. 2A, i.e., the limit voltage Vₘ, so that the drooping type current limiting characteristic as shown in FIG. 2A can be obtained.

As indicated by II in FIG. 5B, when the switches Q1 and Q2 are turned OFF and ON, respectively, the reference voltage V_{ref}′ depends upon the output voltage Vₒᵤₜ. In this case, if the reference voltage V_{ref}′ is determined by the constant current source 231 and the diode circuit 232 to be Vₘ, the reference voltage V_{ref}′ is gradually decreased immediately after the output voltage Vₒᵤₜ is gradually decreased, if the forward voltage of the diode D4 is neglected. Thus, the fold-back (chevron) type current limiting characteristic as shown in FIG. 2B can be obtained.

As indicated by III in FIG. 5B, when the switches Q1 and Q2 are both turned ON, the reference voltage V_{ref}′ also depends upon the output voltage Vₒᵤₜ. In this case, the reference voltage V_{ref}′ determined by the constant current source 231 and the diode circuit 232 is lower than Vₘ, i.e., Vₜ, so that the reference voltage V_{ref}′ is gradually decreased as the output voltage Vₒᵤₜ is gradually decreased, after the output voltage Vₒᵤₜ reaches Vₜ. Also, the forward voltage of the diode D4 is neglected. Thus, the drooping/fold-back type current limiting characteristic as shown in FIG. 2C can be obtained.

Thus, in the first embodiment as illustrated in FIGS. 4, 5A and 5B, the output voltage Vₒᵤₜ is controlled to the limit voltage Vₘ by the constant voltage control circuit C1 formed by the voltage detection signal generating circuit 10 and the current mirror circuit 31, and the control current-to-control voltage converting circuit 40. On the other hand, the output current Iₒᵤₜ is guarded at the limit current Iₘ by the overcurrent or short-circuit protection circuit C2 formed by the current detection signal generating circuit 20 and the current mirror circuit 32. The control of the constant voltage and the control of the overcurrent or short-circuit protection are carried out commonly by the control current generating circuit 30. Thus, the circuit structure can be simplified as compared with the prior art of FIG. 3 where the drooping type current limiting circuit 100 and the fold-back type current limiting circuit 200 are individually provided.

Also, in the first embodiment as illustrated in FIGS. 4, 5A and 5B, three kinds of current limiting characteristics can be obtained by controlling the switches Q1 and Q2.

Further, in the first embodiment as illustrated in FIGS. 4, 5A and 5B, since the gate voltage of the output MOS transistor 1 is controlled by an I/V conversion using the resistor of the control voltage-to-control voltage converting circuit 40, not by the MOS transistors, the gate capacitance of the output MOS transistor 1 can be decreased, which would improve the response characteristic including the response speed of the current limiting characteristic. Additionally, the control current Iₘ can be easily set by changing the resistance value of the resistor of the control current-to-control voltage converting circuit 40. Still, since the fluctuation of the resistance value of the resistor of the control current-to-control voltage converting circuit 40 can be smaller than that of linear regions of MOS transistors, the fluctuation of the limit current Iₘ can be suppressed.

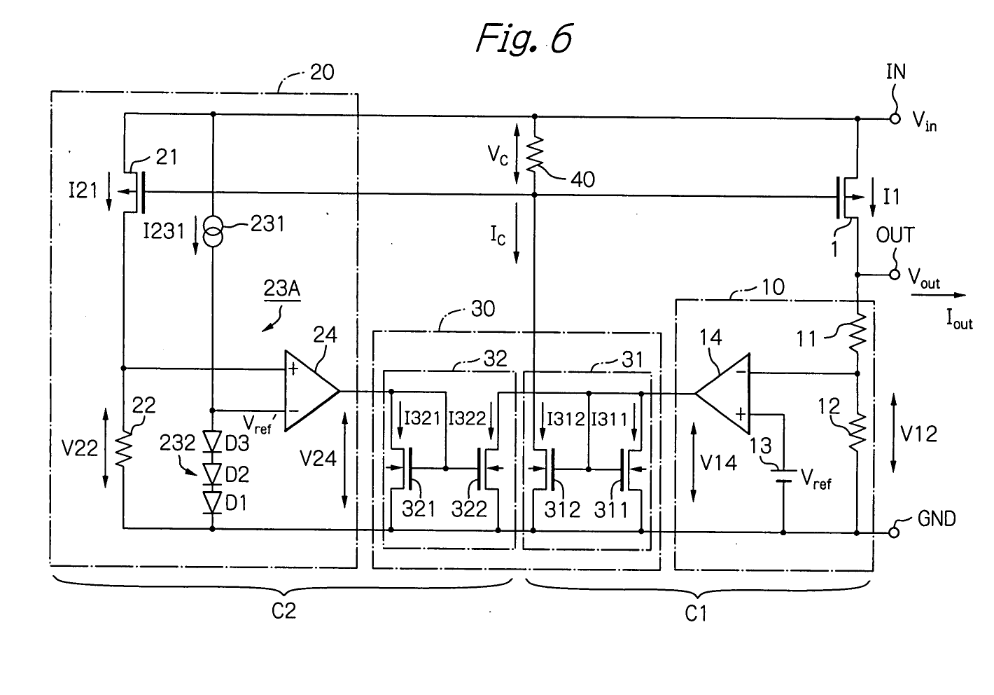

In FIG. 6, which illustrates a second embodiment of the constant voltage generating apparatus according to the present invention, a reference voltage generating circuit 23A is constructed by the constant current source 231 and the diode circuit 232 formed by the diodes D1, D2 and D3 of FIG. 5A. In this case, the drooping type current limiting characteristic as shown in FIG. 2A can be obtained.

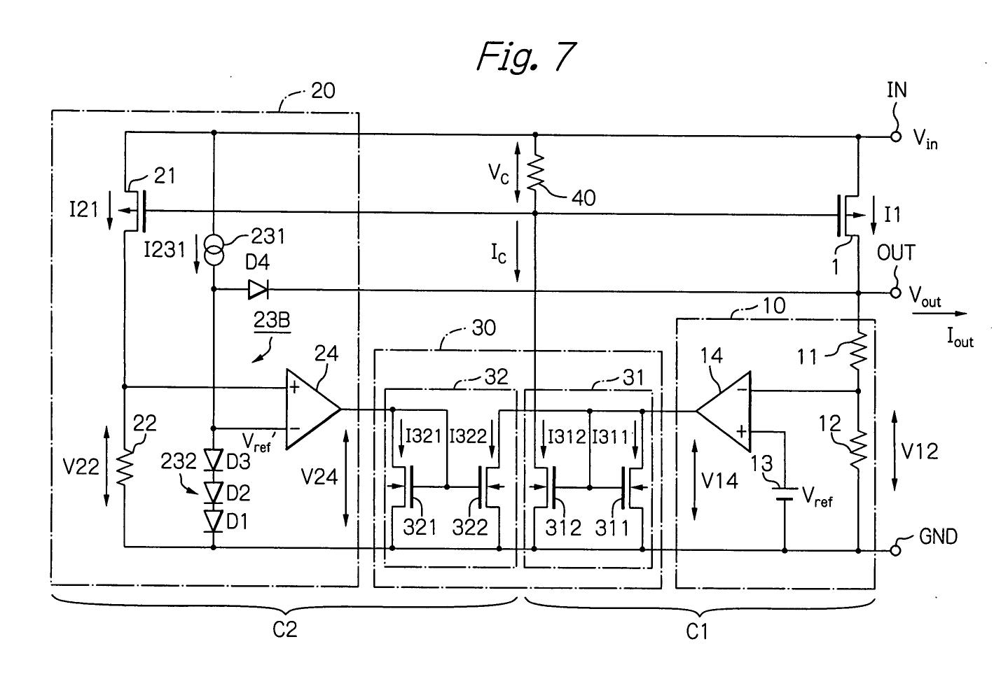

In FIG. 7, which illustrates a third embodiment of the constant voltage generating apparatus according to the present invention, a reference voltage generating circuit 23B is constructed by the constant current source 231 and the diode circuit 232 formed by the diodes D1, D2 and D3, and the diode D4 of FIG. 5A. In this case, the fold-back (chevron) type current limiting characteristic as shown in FIG. 2B can be obtained.

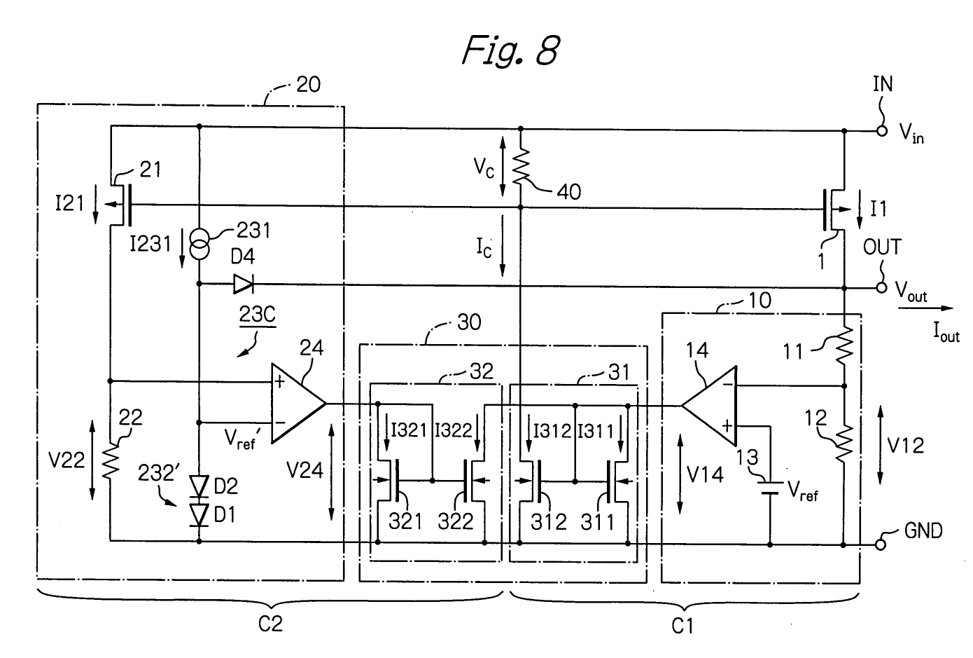

In FIG. 8, which illustrates a fourth embodiment of the constant voltage generating apparatus according to the present invention, a reference voltage generating circuit 23C is constructed by the constant current source 231 and a diode circuit 232′ formed by the diodes D1 and D2, and the diode D4 of FIG. 5A. In this case, the drooping/fold-back type current limiting characteristic as shown in FIG. 2C can be obtained.

In the above-described first embodiment where the switch Q2 is turned ON, and in the third and fourth embodiments, even when the output terminal OUT is short-circuited to the ground terminal GND, the output current Iₒᵤₜ is forcibly decreased to the short-circuit current Iₛ, thus detecting a short-circuit state. Also, when the power is turned ON to increase the output voltage Vₒᵤₜ, a current I223 is supplied immediately from the constant current source 231 to the diode circuit 232 (232′) and to the diode D4 due to the fact that theoutput voltage Vₒᵤₜ is sufficiently low. At this time, since the output current Iₒᵤₜ is also sufficiently low, the current I21 flowing through the MOS transistor 21 is so small that the voltage V22 is surely lower than the reference voltage V_{ref}′. As a result, in an initial state after the power is turned ON, the output state of the comparator 24 is never reversed, thus avoiding an erroneous operation.

In the above-described embodiments, the conductivity type of the MOS transistors can be changed, and also, bipolar transistors can be used instead of the MOS transistors.

As explained hereinabove, according to the present invention, the circuit structure can be simplified to decrease the manufacturing cost, and the response characteristics can be improved.

1. A constant voltage generating apparatus comprising:
an output circuit controlled in accordance with a control voltage;
a voltage detection signal generating circuit adapted to generate a voltage detection signal in accordance with a difference between an output voltage signal of said output circuit and a first reference signal;
a current detection signal generating circuit adapted to generate a current detection signal in accordance with a difference between an output current signal of said output circuit and a second reference signal;
a control current generating circuit adapted to generate a control current in accordance with said voltage detection signal and said current detection signal; and
a control current-to-control voltage converting circuit adapted to convert said control current into said control voltage.

2. The constant voltage generating apparatus as set forth in claim 1, wherein said voltage detection signal generating circuit comprises:
a first detection voltage generating circuit adapted to generate a first detection voltage in accordance with the output voltage signal of said output circuit; and
an error amplifier adapted to amplify a difference between said first detection voltage and said first reference signal to generate said voltage detection signal in accordance with said difference.

3. The constant voltage generating apparatus as set forth in claim 1, wherein said voltage detection signal generating circuit further comprises a voltage divider adapted to divide the output voltage signal of said output circuit to generate said first detection voltage.

4. The constant voltage generating apparatus as set forth in claim 2, wherein said voltage detection signal generating circuit further comprises a reference voltage source adapted to generate a definite voltage as said first reference signal.

5. The constant voltage generating apparatus as set forth in claim 1, wherein said current detection signal generating circuit comprises:
a second detection voltage generating circuit adapted to generate a second detection voltage in accordance with the output current signal of said output circuit; and
a comparator adapted to compare said second detection voltage with said second reference signal to generate said current detection signal.

6. The constant voltage generating apparatus as set forth in claim 5, wherein said second detection voltage generating circuit comprises:
a circuit that forms a current mirror circuit with said output circuit to generate a detection current in response to the output current signal of said output circuit; and
a resistor adapted to convert said detection current into said second detection voltage.

7. The constant voltage generating apparatus as set forth in claim 5, wherein said current detection signal generating circuit further comprises a reference voltage generating circuit adapted to generate said second reference signal.

8. The constant voltage generating apparatus as set forth in claim 7, wherein said reference voltage generating circuit generates one of a definite voltage, and first and second variable voltages,
said definite voltage corresponding to a limit current of the output current signal of said output circuit,
said first variable voltage being decreased immediately after the output voltage signal of said output circuit is decreased from a limit voltage,
said second variable voltage being decreased after the output voltage signal of said output circuit is decreased from a voltage lower than said limit voltage.

9. The constant voltage generating apparatus as set forth in claim 1, wherein said control current generating circuit comprises:
a first current mirror circuit adapted to generate a first current in accordance with said voltage detection signal; and
a second current mirror circuit adapted to generate a second current in accordance with said current detection signal,
said first and second current mirror circuits being combined with each other so that said control current is determined in accordance with a difference between said first and second currents.

10. The constant voltage generating apparatus as set forth in claim 1, wherein said control current-to-control voltage converting circuit comprises a resistor.

11. A constant voltage generating apparatus comprising:
first and second power supply terminals;
an output terminal;
an output transistor connected between said first power supply terminal and said output terminal;
a voltage divider connected between said output terminal and said second power supply terminal and adapted to generate a divided voltage;
an error amplifier connected to said voltage divider and adapted to amplify an error between said divided voltage and a first definite reference voltage to generate a voltage detection signal;
a first current detection transistor connected to said first power supply terminal and forming a current mirror circuit with said output transistor;
a first current-to-voltage converting resistor connected to said first current detection transistor and adapted to generate a current detection voltage;
a comparator connected to said first current-to-voltage converting resistor and adapted to compare said current detection voltage with a second definite voltage to generate a current detection signal;
a second current detection transistor connected between the output of said error amplifier and said second power supply terminal;
a third current detection transistor connected between a control terminal of said output transistor and said second power supply terminal and forming a current mirror circuit with said second current detection transistor;
a fourth current detection transistor connected between the output of said comparator and said second power supply terminal;
a fifth current detection transistor connected between the output of said comparator and said second power supply terminal and forming a current mirror circuit with said fourth current detection transistor; and
a second current-to-voltage converting resistor connected between said first power supply terminal and the control terminal of said output transistor.

12. The constant voltage generating apparatus as set forth in claim 11, wherein said first and second definite reference voltages correspond to a limit voltage and a limit current, respectively, at said output terminal.

13. A constant voltage generating apparatus comprising:
first and second power supply terminals;
an output terminal;
an output transistor connected between said first power supply terminal and said output terminal;
a voltage divider connected between said output terminal and said second power supply terminal and adapted to generate a divided voltage;
an error amplifier connected to said voltage divider and adapted to amplify an error between said divided voltage and a definite reference voltage to generate a voltage detection signal;
a first current detection transistor connected to said first power supply terminal and forming a current mirror circuit with said output transistor;
a first current-to-voltage converting resistor connected to said first current detection transistor and adapted to generate a current detection voltage;
a variable reference voltage generating circuit adapted to generate a variable reference voltage depending upon an output voltage at said output terminal;
a comparator with a first input terminal connected to said first current-to-voltage converting resistor and a second input terminal connected to said variable reference voltage generating circuit, and adapted to compare said current detection voltage with said variable reference voltage to generate a current detection signal;
a second current detection transistor connected between the output of said error amplifier and said second power supply terminal;
a third current detection transistor connected between a control terminal of said output transistor and said second power supply terminal and forming a current mirror circuit with said second current detection transistor;
a fourth current detection transistor connected between the output of said comparator and said second power supply terminal;
a fifth current detection transistor connected between the output of said comparator and said second power supply terminal and forming a current mirror circuit with said fourth current detection transistor; and
a second current-to-voltage converting resistor connected between said first power supply terminal and the control terminal of said output transistor.

14. The constant voltage generating apparatus as set forth in claim 13, wherein said definite reference voltage corresponds to a limit voltage at said output terminal.

15. The constant voltage generating apparatus as set forth in claim 13, wherein said variable reference voltage generating circuit comprises:
a constant current source connected between said first power supply terminal and the second input of said comparator;
a first diode circuit connected between the second input of said comparator and said second power supply terminal; and
a second diode circuit connected between said output terminal and the second input of said comparator.

16. The constant voltage generating apparatus as set forth in claim 15, wherein said first and second diode circuits are determined so that said variable reference voltage is decreased immediately after an output voltage at said output terminal is decreased from a limit voltage at said output terminal.

17. The constant voltage generating apparatus as set forth in claim 15, wherein said first and second diode circuits are determined so that said variable reference voltage is decreased after an output voltage at said output terminal is decreased from a voltage smaller than a limit voltage at said output terminal.
